(19) United States
(12) Patent Application Publication
(10) Pub. No.: US 2026/0283082 A1
(43) Pub. Date: Sep. 24, 2026

(54) ENVIRONMENT CONTROLLING ENCLOSURE

(71) Applicant: JASON RALPH-SMITH ASSOCIATES LIMITED, Farnborough (GB)

(72) Inventor: Jason RALPH-SMITH, Farnborough (GB)

(21) Appl. No.: 19/480,274

(22) PCT Filed: May 2, 2024
(86) PCT No.: PCT/GB2024/051158

§ 371 Date: Oct. 30, 2025

(30) Foreign Application Priority Data
May 2, 2023 (GB) 2306460.3

(51) Int. Cl. A01G 13/27; A47G 7/08

(52) U.S. Cl. CPC A01G 13/27; A47G 7/085

(57) ABSTRACT

There is provided a plant environmental enclosure for a plant container with a permeable sidewall, the plant environmental enclosure comprising a cover configured to, in use, enclose at least part of the plant container, wherein the cover is configurable in size to vary an area of the plant container that is, in use, covered by the cover, and wherein the cover comprises a wall portion configured to, in use, at least partly enclose a sidewall of the plant container, the wall portion being selectively configurable between an extended state and at least one retracted state to vary an area of the sidewall of the plant container that is, in use, covered by the wall portion.

### CROSS-REFERENCE TO RELATED APPLICATIONS

This application is a U.S. national stage application filed under 35 U.S.C. § 371 of International Patent Application No. PCT/GB2024/051158, filed on May 2, 2024, designating the United States, which claims priority from United Kingdom Patent Application Number GB 2306460.3, filed May 2, 2023, both of which are hereby incorporated by reference herein in their entireties.

### FIELD

This disclosure relates to a plant environmental enclosure, preferably for use with a plant container having a permeable sidewall, and to a plant cultivation system comprising a plant environmental enclosure and a plant container.

### BACKGROUND

Plant growth and yield depend on many environmental factors including soil composition, weather and pests. Systems are therefore used to shelter plants from undesired variations in the weather and from pests. One environmental factor that is closely monitored is soil moisture and relative humidity because different plants require different moisture and humidity conditions for optimal plant growth. High levels of humidity and moisture can promote fungal diseases and reduce a plant's growth and yield by adversely affecting the transpiration rate and nutrient absorption of the plant while low levels of humidity and moisture can cause the plant to dry out, stunt its growth and reduce its yield.

Systems for controlling the humidity and moisture of plant containers are therefore crucial to ensure optimal plant growth and yield. Greenhouses are configured to enclose a plurality of plants and create an environment whose humidity and temperature are controlled by way of ventilation, heating, controlling the water supply to the plants, using desiccants or using dehumidifiers. However, greenhouses cannot selectively control the environmental factors of individual plants.

Permeable plant containers, typically made out of fabric, are increasingly used to contain plants and soil due to their low weight and portability which enable them to be transported in large numbers cheaply. However, permeable plant containers do not retain soil moisture as well as impermeable, e.g. plastic, plant containers and thereby allow moisture to permeate or evaporate via its permeable material. The use of permeable plant containers therefore results in increased moisture levels, which presents a challenge for humidity control systems.

### SUMMARY

According to a first aspect of this disclosure, there is provided a plant environmental enclosure for a plant container with a permeable sidewall, the plant environmental enclosure comprising a cover configured to, in use, enclose at least part of the plant container,
wherein the cover is configurable in size to vary an area of the plant container that is, in use, covered by the cover, and
wherein the cover comprises a wall portion configured to, in use, at least partly enclose a sidewall of the plant container, the wall portion being selectively configurable between an extended state and at least one retracted state to vary an area of the sidewall of the plant container that is, in use, covered by the wall portion.

Soil in a plant container stores an amount of water in the form of moisture to enable plant growth. A plant environmental enclosure having a cover configured to, in use, enclose at least part of the plant container advantageously reduces the release of moisture from the plant container to the surrounding air, e.g. by evaporation. Reducing an undesired release of moisture from the plant container can advantageously provide water savings, increase the efficiency of supplying water to the plant container reduce the labour and costs of supplying water to the plant container, and enhance water savings.

Moreover, the cover being configurable in size to vary an area of the plant container that is, in use, covered by the cover provides a simplified control mechanism of the release of moisture from the plant container. Increasing the area of the plant container that is covered will decrease the release of moisture, and decreasing the area of the plant container that is covered will increase the release of moisture.

Controlling the release of moisture from the plant container, which controls the transfer of water from the soil in the plant container to its surrounding environment (i.e. air), also effectively controls the humidity (i.e. water content in the air) of the surrounding environment. In a temperature controlled environment, controlling the release of moisture from the plant container allows the control of the relative humidity of the air surrounding the plant container. This is important as different plants will each require different moisture contents in their plant containers and humidity conditions for optimal growth. Consequently, being able to effect this control by manipulating the cover of the plant environmental enclosure to vary its size and coverage of the plant offers a simple, economical and versatile device usable with a wide range of plants and plant containers to optimise plant growth.

Moreover, the cover of the plant environmental enclosure comprising a wall portion configured to, in use, at least partly enclose the sidewall of the plant container enables the plant environmental enclosure to cover a greater surface area of the plant container, which provides a greater control of the release of moisture from the plant container. This is particularly useful for permeable plant containers, such as fabric plant containers, which suffer the disadvantage of releasing moisture through its sidewalls.

In a preferred embodiment, the wall portion may be configured to, in use, at least partly wrap around the sidewall of the plant container.

The cover at least partly wrapping around the sidewall of the plant container reduces the air circulation between the sidewall of the plant container and the outside air, thus reducing the release of moisture from the plant container through its sidewall.

Moreover, the cover at least partly wrapping around the sidewall of the plant container advantageously provides a compact plant environmental enclosure, which improves its portability and allows for plant environmental enclosures to be installed around multiple adjacent plant containers, each capable of being independently controlled.

In some embodiments, the cover may be made of an impermeable material, such as a water-impermeable material or a liquid-impermeable material. The cover being made of an impermeable material advantageously prevents any moisture from diffusing through the cover and thereby provides an effective barrier that enables a significant reduction of the release of moisture from the plant container depending on the area of the plant container covered by the cover.

In further embodiments, the wall portion in the extended state may be configured to, in use, fully enclose the sidewall of the plant container. The wall portion being configured to fully enclose the sidewall of the plant container in its extended state allows the plant environmental enclosure to minimise the release of moisture from the plant container along its sidewall. This in turn also provides a greater range of control of the reduction of the release of moisture from the plant container along its sidewall.

In some embodiments, the at least one retracted state may include at least one folded state and/or at least one rolled up state. Having any one of at least one folded state and/or at least one rolled up state provides a simple mechanism to reduce the area of the sidewall that is covered by the wall portion of the cover and control the release of moisture from the plant container. The retracted state including at least one folded state allows for a fast and easy transition between the extended state and the retracted state. The retracted state including at least one rolled up state allows for an arrangement that does not require additional components for retaining the wall portion in its retracted state.

In some embodiments, the plant environmental enclosure may comprise at least one wall portion retaining member (such as a fastener or a strap) configured to releasably retain the wall portion in the at least one retracted state. The provision of such a wall portion retaining member advantageously ensures that the wall portion remains in its retracted state and does not accidentally return to its extended state, thus ensuring consistent control of the reduction of the release of moisture from the plant container. This is particularly useful for cases where the at least one retracted state includes at least one folded state.

In addition, the provision of at least one wall portion retaining member can also facilitate the selection and maintenance of a specific coverage of the plant container's sidewall with greater consistency and accuracy than relying on manual adjustments. A specific coverage may be linked to a particular moisture level required by a particular plant inside the plant container. The provision of at least one wall portion retaining member therefore improves the control of the release of moisture for particular plants.

In further embodiments, the plant environmental enclosure may comprise a plurality of wall portion retaining members. Alternatively only one wall portion retaining member may be used to retain the wall portion in more than one retracted state, e.g. the wall portion retaining member being a strap. This provides the above mentioned benefits and additionally allows more than one retracted state to be selected.

In further embodiments, the plant environmental enclosure may comprise at least one connecting member distanced from the at least one wall portion retaining member, each of the at least one connecting member and the at least one wall portion retaining member being disposed on the wall portion, the at least one wall portion retaining member being configured to releasably retain the at least one connecting member so that the wall portion may be retained in the at least one retracted state. The combination of the connecting member and the retaining member may be any one of a clip fastening mechanism, a magnetic fastening mechanism, a hook and loop fastening mechanism and a snap fit fastening mechanism.

The provision of at least one connecting member facilitates the retention of the wall portion in its at least one retracted state and helps ensure consistent control of the reduction of the release of moisture from the plant container. This is because the at least one connecting member provides a component disposed on the wall portion that is specifically configured to be retained by the wall portion retaining member.

In some embodiments, the plant environmental enclosure may further comprise at least one fastening element, and the cover may comprise at least one cover segment defining a first edge and a second edge, the first edge and the second edge being releasably connectable to each other by the at least one fastening element so that, in use, the cover encloses at least part of the plant container.

The at least one cover segment comprising the releasably connectable first and second edges advantageously allows the plant environmental enclosure to be flattened which facilitates its suitability for transportation. The first and second edges of the cover being connectable in such a way also facilitates the installation of the plant environmental enclosure around the plant container because the cover can be fitted around the plant container.

Moreover, the cover defining the releasably connectable first and second edges facilitates the selective configuration of the cover in the retracted state, therefore facilitating control of the reduction of the release of moisture from the plant container. In some embodiments, the cover may comprise two or more cover segments each defining a first edge and a second edge, each of the first edge and the second edge of each cover segment being releasably connectable to the second edge and the first edge of another cover segment respectively by at least one fastening element so that, in use, the cover encloses at least part of the plant container.

The cover comprising two or more cover segments releasably connectable to each other allows for the wall portion of each cover segment to be selectively configured between the extended state and the retracted state independently, thus advantageously increasing the control of the reduction of the release of moisture from the plant container.

In further embodiments, the at least one fastening element may include a hook and loop fastener. Alternatively, the at least one fastening element may be any one of a magnetic fastener, a zip fastener and a snap fit fastener.

The at least one fastening element being any one of the above mentioned fasteners allows for the easy connection and disconnection of the first and second edges of the at least one cover segment. The provision of at least one fastening element therefore facilitates the selective configuration of the wall portion of the at least one cover segment, which in turn facilitates control of the reduction of the release of moisture from the plant container.

In some embodiments, the plant environmental enclosure may have a three-dimensional hollow elongate shape. The three-dimensional hollow elongate shape may, for example, be a tubular shape or a hollow polygonal shape.

The plant environmental enclosure having such shapes, similar to those of typical plant containers, allows it to fit closely around the plant container. This in turn allows the plant environmental enclosure to reduce the release of moisture from the plant container more effectively.

In some embodiments, the cover may comprise a top portion configured to, in use, at least partly enclose a top of the plant container, and wherein the top portion may be configurable in size to vary an area of the plant container that is, in use, covered by the top portion.

The cover comprising a top portion advantageously reduces evaporation of moisture from the plant container via its top. This is particularly useful because the soil of the plant container is exposed at its top and is therefore more susceptible to releasing moisture from the plant container when it is heated by the sun or another heat source. In addition, the top cover being configurable in size to vary an area of the plant container that is, in use, covered by the top portion allows a user to further control the release of moisture from the plant container by allowing a user to increase or reduce the release of moisture from the plant container via its top. This also allows the top portion to be adjustable to receive therethrough plants of varying height, width and stem size.

Moreover, the top portion can further advantageously act as a barrier that prevents insects from laying their eggs in the soil of the plant container. The provision of an environmental enclosure with such a top portion can therefore improve the health outcome of a plant inside the plant container.

The top portion provides the plant environmental enclosure with a simple and secure arrangement to facilitate its retention on the plant container, i.e. it enables the plant environmental enclosure to rest on top of the plant container.

In some embodiments, the top portion may be configured to, in use, wrap around a stem of a plant extending therethrough.

The top portion being configured to wrap around a stem of a plant minimises the release of moisture from the plant container and maximises protection from insects by minimising the space between the top cover and the stem through which moisture can be released and through which insects can access the plant container.

In further embodiments, the environmental enclosure may comprise at least one top portion retaining member configured to releasably retain the top portion in one of an expanded state and a contracted state. The top portion retaining member may, for example, be a drawstring.

The provision of a top portion retaining member ensures that the top portion remains in a selected expanded state or contracted state. The contracted state may be configured to match a particular plant stem width, therefore improving control of the release of moisture from the plant container and ensuring protection from insects.

In some embodiments, the wall portion and the top portion may be detachably connected to each other. The plant environmental enclosure comprising such detachably connected parts facilitates the control of the release of moisture from the plant container, i.e. any one of the wall portion or the top portion can be added or removed depending on the weather conditions and moisture requirements of a particular plant to achieve the desired reduction in the release of moisture from the plant container.

In some embodiments, the cover may be made of a flexible material. The cover being made of a flexible material facilitates its storage and transport as it can be folded. In addition, the cover being made of a flexible material enables it to be wrapped around

a variety of plant containers having different diameters and cross-sectional shapes. The cover being made of a flexible material therefore allows the plant environmental enclosure to provide a good fit that ensures an effective and consistent reduction of the release of moisture from the plant container for a variety of plant containers.

In some embodiments, an exterior facing surface of the cover may include a reflective material.

The exterior facing surface of the cover including a reflective material advantageously reflects light from the environmental plant container and reduces heat transfer from the sun to the plant container. Such a cover reduces heating of the plant container and therefore reduces the release of moisture from the plant container.

In some embodiments, the cover may define an opening that is located, in use, on its bottom side and configured to, in use, allow access to the base of the plant container. The cover defining such an opening allows the base of the plant container to be uncovered. This allows water to be delivered directly to the base of the plant container and without needing to reconfigure the plant environmental enclosure. Such a plant environmental enclosure increases the efficiency of supplying water to the plant container, which reduces the labour and costs of supplying water to the plant container. It may, for example, allow plant containers to be watered automatically by a water supply system. In addition, such an opening facilitates installation of the plant environmental enclosure since it can be fitted around a plant container and does not require the plant container to be lifted or moved.

According to a second aspect of this disclosure, there is provided a plant environmental enclosure for a plant container with a permeable sidewall, the environmental enclosure comprising:
a cover configured to, in use, enclose at least part of the plant container,
wherein the cover is configurable in size to vary an area of the plant container that is, in use, covered by the cover, and
wherein an exterior facing surface of the cover includes a reflective material.

The advantages of the preceding aspect of this disclosure and its embodiments apply mutatis mutandis to the second aspect of this disclosure and its embodiments in so far as they share the same or corresponding features.

In further embodiments, the cover may comprise a wall portion configured to, in use, at least partly enclose the sidewall of the plant container.

In a preferred embodiment, the wall portion may be configured to, in use, at least partly wrap around the sidewall of the plant container.

In some embodiments, the cover may be made of an impermeable material.

In further embodiments, the wall portion in the extended state may be configured to, in use, fully enclose the sidewall of the plant container.

In still further embodiments, the wall portion in the at least one retracted state may be configured to, in use, fully surround the sidewall of the plant container. This allows the wall portion in the at least one retracted state to form an uninterrupted enclosure around the plant container.

In some embodiments, the plant environmental enclosure may have a three-dimensional hollow elongate shape. The three-dimensional hollow elongate shape may be, for example, a tubular shape or a hollow polygonal shape.

In some embodiments, the plant environmental enclosure may further comprise at least one fastening element, and the cover may comprise at least one cover segment defining a first edge and a second edge, the first edge and the second edge being releasably connectable to each other by the at least one fastening element so that, in use, the cover encloses at least part of the plant container.

In some embodiments, the cover may comprise two or more cover segments each defining a first edge and a second edge, each of the first edge and the second edge of each cover segment being releasably connectable to the second edge and the first edge of another cover segment respectively by at least one fastening element so that, in use, the cover encloses at least part of the plant container.

In further embodiments, the at least one fastening element may include a hook and loop fastener. Alternatively, the at least one fastening element may be any one of a magnetic fastener, a zip fastener and a button.

In further embodiments, the cover may comprise a top portion configured to, in use, at least partly enclose a top of the plant container, and wherein the top portion may be configurable in size to vary the area of the plant container that is, in use, covered by the top portion.

In further embodiments, the top portion may be configured to, in use, wrap around a stem of a plant extending therethrough.

In further embodiments, the environmental enclosure may comprise at least one top portion retaining member configured to releasably retain the top portion in one of an expanded state and a contracted state. The top portion retaining member may, for example, be a drawstring.

In some embodiments, the wall portion and the top portion may be detachably connected to each other.

In some embodiments, the wall portion may be configured to, in use, at least partly enclose the sidewall of the plant container, the wall portion being selectively configurable between an extended state and at least one retracted state to vary an area of the sidewall of the plant container that is, in use, covered by the wall portion.

In some embodiments, the at least one retracted state may include at least one folded state and/or at least one rolled up state.

In some embodiments, the plant environmental enclosure may comprise at least one wall portion retaining member configured to releasably retain the wall portion in the at least one retracted state.

In addition, the provision of at least one wall portion retaining member can also facilitate selecting and maintaining a specific coverage of the plant container's sidewall with greater consistency and accuracy than relying on manual adjustments. A specific coverage may be linked to a particular moisture level required by a particular plant inside the plant container.

In further embodiments, the plant environmental enclosure may comprise a plurality of wall portion retaining members. Alternatively only one wall portion retaining member may be used to retain the wall portion in more than one retracted state, e.g. the wall portion retaining member being a strap.

In further embodiments, the plant environmental enclosure may comprise at least one connecting member distanced from the at least one wall portion retaining member, each of the at least one connecting member and the at least one wall portion retaining member being disposed on the wall portion, the at least one wall portion retaining member being configured to releasably retain the at least one connecting member so that the wall portion may be retained in the at least one retracted state. The combination of the connecting member and the retaining member may be any one of a clip mechanism, a magnetic mechanism, a hook and loop mechanism and a button mechanism.

In some embodiments, the cover may be made of a flexible material.

In some embodiments, the cover may define an opening located, in use, on its bottom side and configured to allow access to the base of the plant container.

According to a third aspect of the disclosure, there is provided a plant environmental enclosure for a plant container with a permeable sidewall, the environmental enclosure comprising:
a cover configured to, in use, enclose at least part of the plant container,
wherein the cover is configurable in size to vary an area of the plant container that is, in use, covered by the cover, and
wherein the cover defines an opening that is located, in use, on its bottom side and configured to, in use, allow access to the base of the plant container.

The advantages of the preceding aspects of this disclosure and their embodiments apply mutatis mutandis to the third aspect of this disclosure and its embodiments in so far as they share the same or corresponding features.

In further embodiments, the cover may comprise a wall portion configured to, in use, at least partly enclose the sidewall of the plant container.

In a preferred embodiment, the wall portion may be configured to, in use, at least partly wrap around the sidewall of the plant container.

In some embodiments, the cover may be made of an impermeable material.

In further embodiments, the wall portion in the extended state may be configured to, in use, fully enclose the sidewall of the plant container.

In some embodiments, the plant environmental enclosure may have a three-dimensional hollow elongate shape. The three-dimensional hollow elongate shape may, for example, be a tubular shape or a hollow polygonal shape.

In some embodiments, the plant environmental enclosure may further comprise at least one fastening element, and the cover may comprise at least one cover segment defining a first edge and a second edge, the first edge and the second edge being releasably connectable to each other by the at least one fastening element so that, in use, the cover encloses at least part of the plant container.

In some embodiments, the cover may comprise two or more cover segments each defining a first edge and a second edge, each of the first edge and the second edge of each cover segment being releasably connectable to the second edge and the first edge of another cover segment respectively by at least one fastening element so that, in use, the cover encloses at least part of the plant container.

In further embodiments, the at least one fastening element may include a hook and loop fastener. Alternatively, the at least one fastening element may be any one of a magnetic fastener, a zip fastener and a button.

In further embodiments, the cover may comprise a top portion configured to, in use, at least partly enclose a top of the plant container, and wherein the top portion may be configurable in size to vary the area of the plant container that is, in use, covered by the top portion.

In further embodiments, the top portion may be configured to, in use, wrap around a stem of a plant extending therethrough.

In further embodiments, the environmental enclosure may comprise at least one top portion retaining member configured to releasably retain the top portion in one of an expanded state and a contracted state. The top portion retaining member may, for example, be a drawstring.

In some embodiments, the wall portion and the top portion may be detachably connected to each other.

In some embodiments, the wall portion may be configured to, in use, at least partly enclose the sidewall of the plant container, the wall portion being selectively configurable between an extended state and at least one retracted state to vary an area of the sidewall of the plant container that is, in use, covered by the wall portion.

In some embodiments, the at least one retracted state may include at least one folded state and/or at least one rolled up state.

In some embodiments, the plant environmental enclosure may comprise at least one wall portion retaining member configured to releasably retain the wall portion in the at least one retracted state.

In further embodiments, the plant environmental enclosure may comprise a plurality of wall portion retaining members. Alternatively only one wall portion retaining member may be used to retain the wall portion in more than one retracted state, e.g. the wall portion retaining member being a strap.

In further embodiments, the plant environmental enclosure may comprise at least one connecting member distanced from the at least one wall portion retaining member, each of the at least one connecting member and the at least one wall portion retaining member being disposed on the wall portion, the at least one wall portion retaining member being configured to releasably retain the at least one connecting member so that the wall portion may be retained in the at least one retracted state. The combination of the connecting member and the retaining member may be any one of a clip mechanism, a magnetic mechanism, a hook and loop mechanism and a button mechanism.

In some embodiments, the cover may be made of a flexible material.

In some embodiments, an exterior facing surface of the cover may include a reflective material.

According to a fourth aspect of the disclosure, there is provided a plant cultivation system comprising: the plant environmental enclosure according to any one of the above aspects of the disclosure and their embodiments; and a plant container with a permeable sidewall.

The plant cultivation system shares the benefits of the above described plant environmental enclosures.

In a preferred embodiment, the cover may be less permeable than the permeable sidewall of the plant container.

The cover of the plant environmental enclosure being less permeable than the permeable sidewall of the plant container allows the plant environmental enclosure to reduce the release of moisture from the plant container.

In a further preferred embodiment, the plant cultivation system may further comprise a water supply system configured to supply water to a plant inside the permeable plant container via its base.

The plant cultivation system comprising such a water supply system advantageously allows the plant inside the permeable plant container to be supplied with water directly without needing to reconfigure the plant environmental enclosure. The plant can therefore be automatically watered by the water supply system, making the plant cultivation system a water efficient system that requires little user intervention.

It will be appreciated that the use of the terms “first” and “second”, and the like, in this patent specification is merely intended to help distinguish between similar features, and is not intended to indicate the relative importance of one feature over another feature, unless otherwise specified.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Preferred embodiments will now be described, by way of non-limiting examples, with reference to the accompanying drawings in which:

FIG. 1 shows a perspective view of a plant container;

FIG. 2A shows a front view of a plant environmental enclosure, in use, according to an embodiment;

FIG. 2B shows the plant environmental enclosure of FIG. 2A from a top view;

FIG. 3A shows the plant environmental enclosure of FIG. 2A having a top portion in a contracted state;

FIG. 3B shows the plant environmental enclosure of FIG. 3A from a top view;

FIGS. 4A-4C show the plant environmental enclosure of FIG. 3A having a wall portion in an expanded state and retracted states respectively;

FIGS. 5A and 5B show front views of a plant environmental enclosure according to another embodiment having the wall portion in the expanded state and in the contracted state respectively;

FIG. 5C shows a top view of the plant environmental enclosure of FIG. 5A;

FIGS. 6A and 6B show front views of a plant environmental enclosure according to another embodiment having the wall portion in the expanded state and in the retracted state respectively;

FIG. 6C shows a top view of the plant environmental enclosure of FIG. 6A;

FIGS. 6D-6F show the plant environmental enclosure of FIGS. 6A-6C having the wall portion in various retracted states;

FIG. 7A shows a front view of a plant environmental enclosure according to another embodiment;

FIG. 7B shows a perspective view of a plant environmental enclosure according to another embodiment; and

FIG. 8 shows a front view of a plant cultivation system according to another embodiment.

The figures are not necessarily to scale, and certain features and certain views of the figures may be shown exaggerated in scale or in schematic form in the interests of clarity and conciseness.

### DETAILED DESCRIPTION

The following embodiments of this disclosure are described with reference to fabric plant containers, but it will be appreciated that the following embodiments are applicable mutatis mutandis to other plant containers, particularly other plant containers with permeable sidewalls.

The listing or discussion of an apparently prior-published document or apparently prior-published information in this specification should not necessarily be taken as an acknowledgement that the document or information is part of the state of the art or is common general knowledge.

Preferences and options for a given aspect, feature or parameter should, unless the context indicates otherwise, be regarded as having been disclosed in combination with any and all preferences.

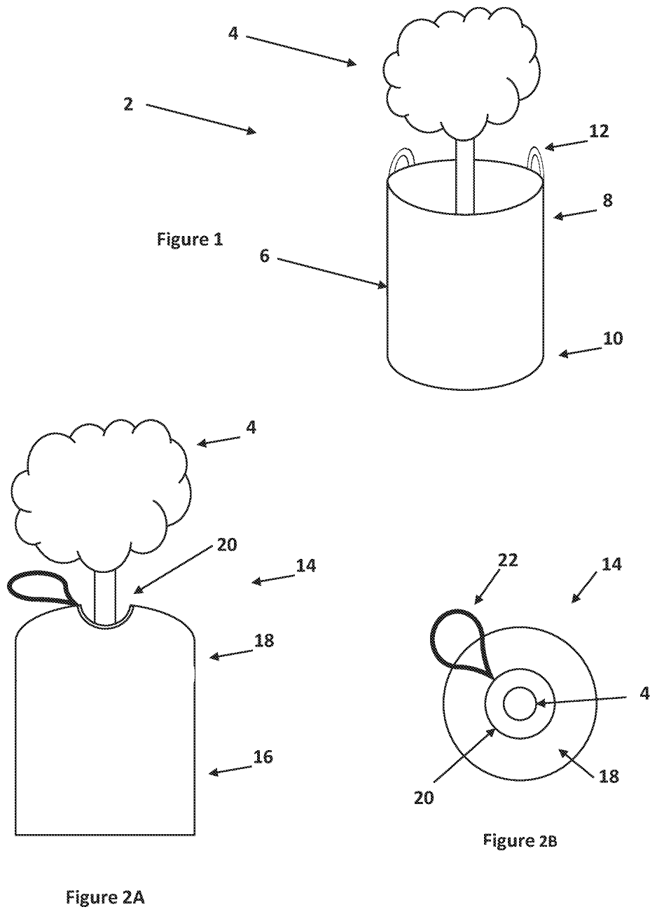

FIG. 1 shows a perspective view of a plant container 2 comprising soil and a plant 4 planted in the soil. The plant container 2 is made of a permeable material such as a fabric, which may be a woven fabric. The plant container 2 comprises a sidewall 6 extending along its length, i.e. height, between a top 8 and a base 10. The sidewall 6 is a permeable sidewall and the base 10 is a permeable base. The top of the plant container 2 defines an opening to allow the insertion of the soil and the plant. The plant container 2 additionally comprises an optional pair of handles 12 disposed on the top of the plant container 2.

The plant container 2 allows the transfer of water between, i.e. to and from, the soil and the surrounding environment via the top 8, the permeable sidewall 10 and the permeable base 10. The plant container 2 shown in FIG. 1 is a permeable plant container. In other embodiments, the plant container may be a plant pot or a planter, and/or may be made of other materials such as clay, plastic or ceramic.

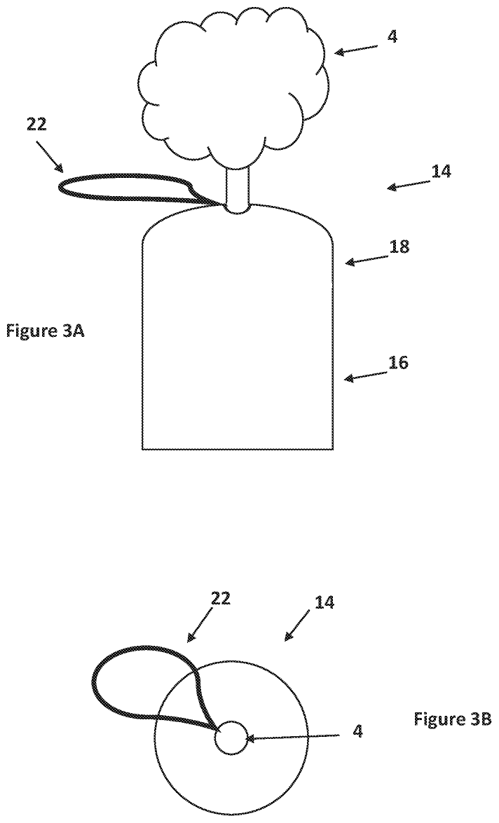

FIG. 2A shows a front view of a plant environmental enclosure 14 in use. The plant environmental enclosure 14 comprises a cover that, in use, encloses the plant container 2 of FIG. 1. The cover comprises a wall portion 16 configured to enclose the permeable sidewall 6 of the plant container 2 and a top portion 18 configured to enclose the top 8 of the plant container 2.

The cover covering the plant container 2 reduces or stops the release of moisture, i.e. transfer of water, from the plant container 2 to the surrounding environment via its sidewall 6. The top portion 18 of the cover being in the contracted state further reduces or stops the release of moisture from the plant container 2 to the surrounding environment via its top 8.

The cover is made of an impermeable material, i.e. a material that does not permit a fluid transfer through it, to maximise the retention of moisture in the plant container 2. The cover is additionally and optionally made of a flexible material. The cover can, for example, be made of a plastic such as polyethylene. Examples of polyethylene include high density polyethylene, and biaxially-oriented polyethylene terephthalate (BoPET) also known by the trade mark “Mylar”. In other embodiments, the cover may be made of materials of varying permeability to vary the rate of release of moisture from the plant container 2 to the surrounding environment.

The exterior facing surface of the cover additionally includes a reflective material capable of reflecting sunlight such as BoPET. In other embodiments, the cover may be made of a relatively reflective material (e.g. white in colour) to partially reduce the light and heat absorbed by the plant environmental enclosure. In further embodiments, the cover may be made of an insulating material and/or a relatively non-reflective material (e.g. black in colour) to partially increase the light and heat absorbed by the plant container 2. In other embodiments, the cover may comprise any number of multiple layers of different materials and/or coatings.

The cover defines an opening that is located, in use, on its bottom side and is configured to allow access to the permeable base 10 of the plant container 2. The plant environmental enclosure 14 can therefore be deployed over the plant container 2 and fit around it. The opening on its bottom side also allows for the supply of water to the plant container 2 via its permeable base 10 while the plant environmental enclosure 14 is deployed on the plant container 2.

The cover also defines an opening 20 located on its top portion 18 that allows part of the plant 4 to extend therethrough, such as the stem of the plant 4. FIG. 2A shows the top portion 18 of the cover in an expanded state in which the opening 20 of the top portion 18 defines a gap around the stem of the plant 4.

FIG. 2B shows a schematic representation of the plant environmental enclosure 14 shown in FIG. 2A as seen from above, i.e. a top view that omits a top part the plant 4 for clarity. The plant environmental enclosure 14 is shown to have a circular cross-section. The opening 20 of the top portion 18 defines an area of the plant container 2 that is not covered by the top portion 18.

The cover is configurable in size to vary an area of the plant container 2 that is, in use, covered by the cover, i.e. the shape of the cover and the volume it occupies can be manipulated relative to the plant container 2 to vary the area of the plant container 2 that is covered by the plant container 2. The cover covering the plant container 2 does not necessarily require the cover to be in contact with the whole corresponding area of the plant container 2, although the cover could be in contact with the whole corresponding area of the plant container 2 in some embodiments. The cover covering the plant container 2 means that the surface of the cover overlaps with the surface of the plant container 2 in a way that would block sunrays and/or fluid transfers to or from the surface of the plant container 2.

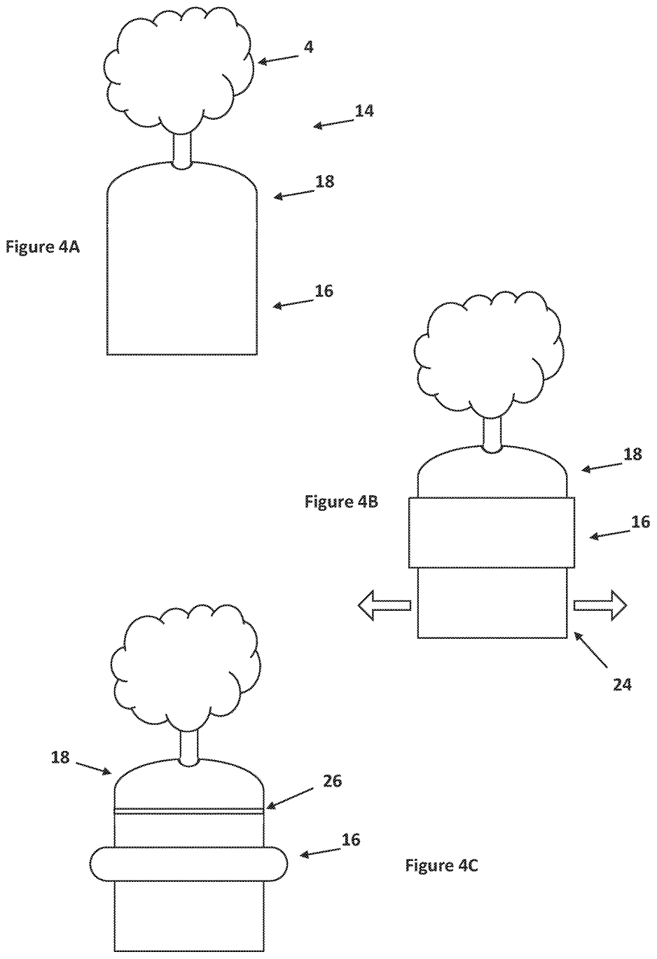

The top portion 18 is selectively configurable between the expanded state and a contracted state to vary the area of the plant container 2 that is covered by the top portion 18. FIGS. 3A and 3B show the plant environmental enclosure 14 of FIGS. 2A and 2B, respectively, in the contracted state.

The opening 20 of the top portion 18 has a smaller diameter in the contracted state than in the expanded state. Consequently, the area of the plant container 2 that is covered by the cover is greater in the contracted state than in the expanded state. In the contracted state shown in FIGS. 3A and 3B the top portion 18 of the cover wraps around the stem of the plant 4.

The plant environmental enclosure 14 can control the amount of water that is released from the top of the plant container 2, e.g. through evaporation, by varying the area of the plant container 2 that is covered by the top portion 18 of the cover. The top portion 18 can be selectively configured to be in the expanded state to promote the release of moisture from the plant container 2 to the surrounding environment via the opening by decreasing the area of the plant container 2 that is covered by the top portion 18. The top portion 18 can also be selectively configured to be in the contracted state to reduce the release of moisture from the plant container 2 to the surrounding environment via the opening defined by increasing the area of the plant container 2 that is covered by the top portion 18.

The plant environmental enclosure 14 additionally comprises a top portion retaining member 22 shown in FIGS. 2A-3B as a drawstring. The top portion retaining member 22 facilitates the selective transition of the top portion 18 of the cover between the expanded state and the contracted state. It also facilitates the retention of the top portion 18 of the cover in a selected state out of the expanded state, the contracted state and an intermediate state between the expanded state and the contracted state.

In such an intermediate state the opening 20 of the top portion 18 may have a diameter smaller than in the expanded state and larger than in the contracted state.

The plant environmental enclosure 14 comprising a selectively configurable top portion 18 and an opening on its bottom side allows for water to be supplied to the plant container 2 via its top when the top portion 18 of the cover is in the expanded state and for water to drain through the permeable base 10 of the plant container 2. It also allows for water to be supplied to the plant container 2 via its permeable base 10 when the top portion 18 of the cover is in the contracted state.

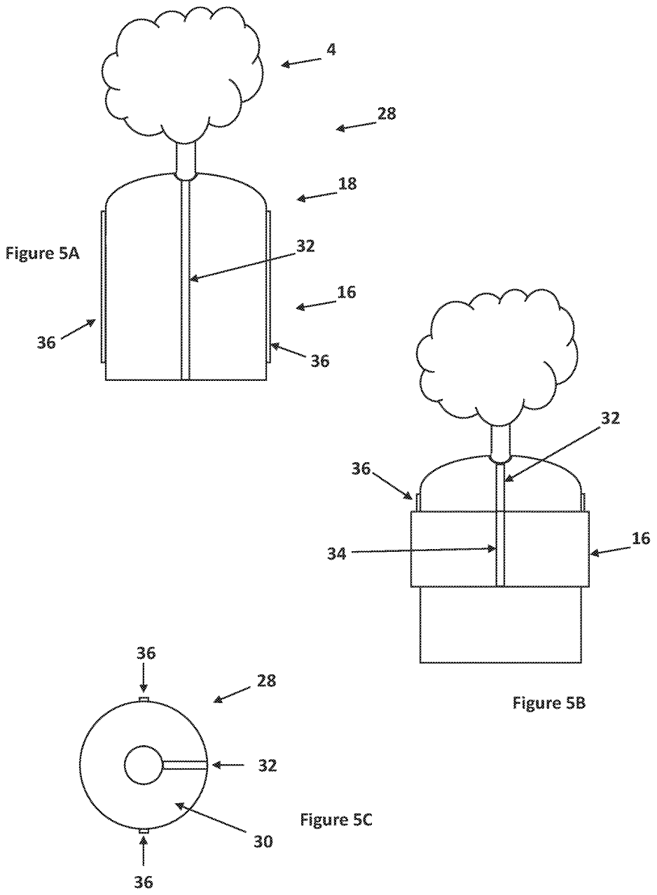

FIG. 4A shows a plant environmental enclosure 14 similar to the one described in relation to FIGS. 2A-3B comprising a cover that has the top portion 18 in the contracted state but the top portion retaining member 22 is omitted. FIG. 4A shows the wall portion 16 of the cover being, in use, selectively configured to be in an extended state in which the wall portion 16 fully encloses the sidewall 6 of the plant container 2, i.e. it covers the entire area of the sidewall 6 of the plant container 2.

The plant environmental enclosure 14 can control the amount of moisture that is released from the sidewall 6 of the plant container 2, e.g. through evaporation, by varying the area of the plant container 2 that is covered by the wall portion 16 of the cover. The wall portion 16 can be selectively configured to be in a retracted state, shown in FIG. 4B, to promote the release of moisture from the plant container 2 to the surrounding environment via the sidewall 6 of the plant container 2. The wall portion 16 can also be selectively configured to be in the extended state to reduce the release of moisture from the plant container 2 to the surrounding environment via the sidewall 6 of the plant container 2.

In FIG. 4B the wall portion 16 of the cover is folded to selectively transition from the extended state into the retracted state, the retracted state being in this case a folded state. The wall portion 16 being selectively configured to be in a retracted state reduces the area of the sidewall 6 of the plant container 2 that is covered by the wall portion 16. This results in a lower portion 24 of the sidewall 6 being exposed to the surrounding environment which allows the transfer of water between the plant container 2 and the surrounding environment. The release of moisture from the plant container 2 to the surrounding environment is illustrated by way of arrows.

It will be appreciated that the retracted state shown in FIG. 4B is one of many retracted states to which the wall portion 16 can be configured, each retracted state covering a respective different amount of the area of the sidewall 6.

FIG. 4C shows an alternative arrangement of the wall portion 16 in which the wall portion 16 is rolled upwardly to expose the lower portion 24 of the sidewall 6. In this case the retracted state is a rolled up state. The cover shown in FIGS. 4B and 4C is made of a material that is sufficiently flexible and provides sufficient friction for the wall portion 16 to be retained in the retracted state.

In addition, the top portion 18 and the wall portion 16 of the plant environmental enclosure 14 shown in FIG. 4C are detachably connected to each other. The plant environmental enclosure 14 further comprises a top portion fastening element 26 configured to allow the connection and detachment of the top portion 18 and the wall portion 16. The top portion fastening element 26 is disposed around the circumference of the cover between the top portion 18 and the wall portion 16. It is shown in FIG. 4C as a zip mechanism but may take the form of another type of fastening mechanism in other embodiments.

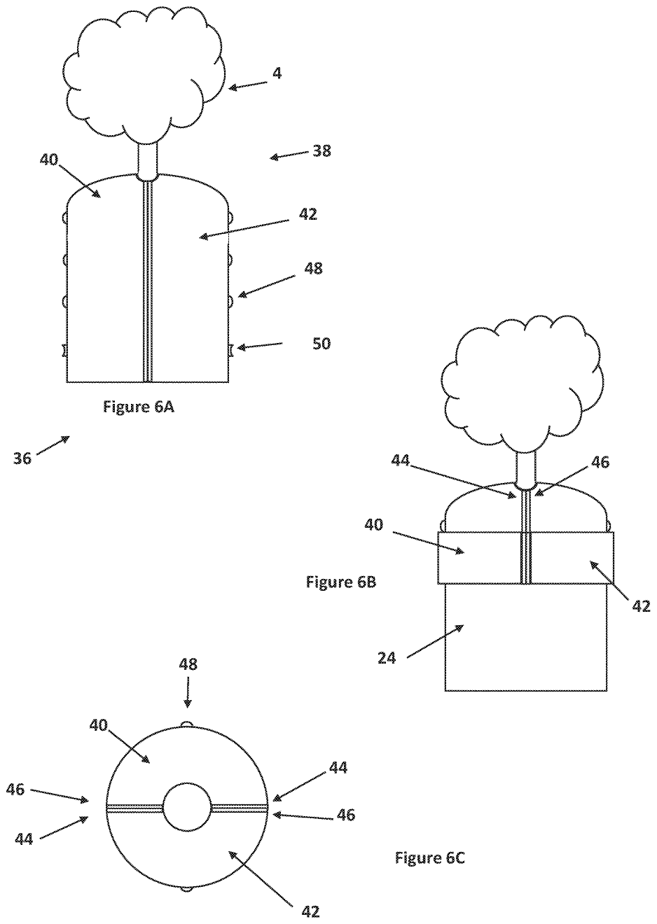

FIGS. 5A and 5B show an alternative embodiment 28 of the plant environmental enclosure of FIGS. 4A and 4B, respectively, in which the plant environmental enclosure 28 comprises a cover segment 30 defining a first edge 32 and a second edge 34 that are releasably connectable to each other.

The plant environmental enclosure 28 additionally comprises a fastening element 36, shown as a hook and loop fastener, arranged along the length of the cover on the first edge 32 and the second edge 34 to enable the releasable connection of the first edge 32 and the second edge 34. The first edge 32 is laid on top of the second edge 34 so that the second edge 34 is visible in FIG. 5B when the wall portion 16 is in the retracted state. In other embodiments the fastening element may be any other suitable fastening element such as a zip fastener.

FIGS. 5A and 5B show the first edge 32 and the second edge 34 connected to each other so that the plant environmental enclosure 28, in use, encloses the plant container 2. FIG. 5C shows the plant environmental enclosure 28 from a top view.

The plant environmental enclosure 28 can be deployed by fastening the first edge 32 to the second edge 34 and fitting the plant environmental enclosure 28 over the plant container 2. Alternatively, the plant environmental enclosure 28 can be first wrapped around the plant container 2 and the first edge 32 can then be connected to the second edge 34 to secure the plant environmental enclosure 28 around the plant container 2. The plant environmental enclosure 28 shown in FIGS. 5A-5C additionally comprises a pair of wall portion retaining members 36 configured to releasably retain the wall portion 16 in a plurality of retracted states.

The wall portion retaining members 36 are arranged on the wall portion 16 along the length of the cover on either side of the first edge 32 and the second edge 34. FIG. 5B shows the plant environmental enclosure 28 in a retracted, folded state in which the wall portion 16 on either side of the first edge 32 and second edge 34 is supported by the wall portion retaining members 36 to retain the wall portion 16 in the retracted state. Each wall portion retaining member may be any suitable member that provides a releasable connection such as a hook and loop fastener.

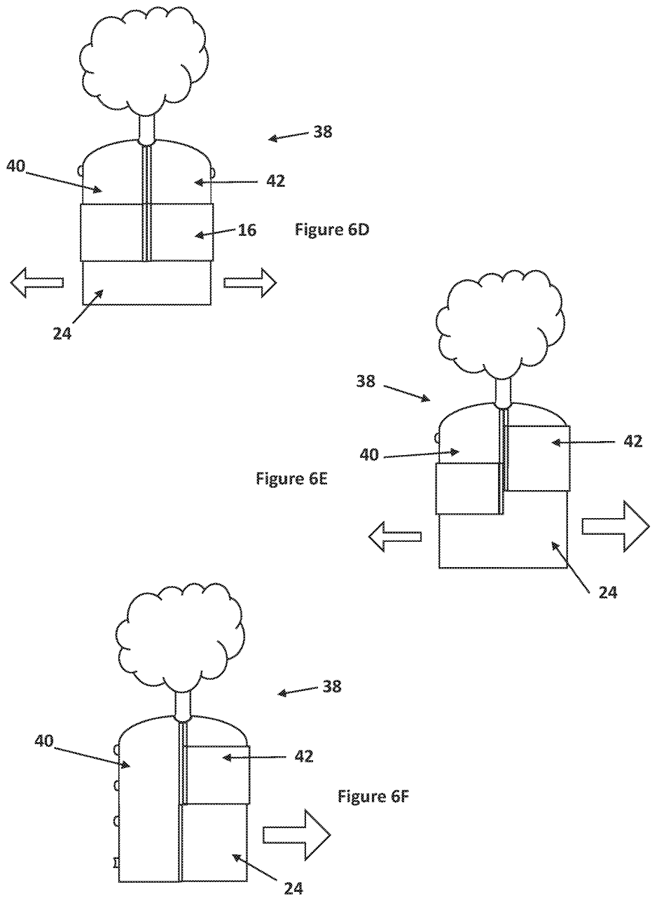

FIGS. 6A-6C show another embodiment of the plant environmental enclosure 38 corresponding to the views of FIGS. 5A-5C, respectively. As shown in FIG. 6C, the plant environmental enclosure 28 comprises a first cover segment 40 and a second cover segment 42. Each cover segment 40,42 comprises a first edge 44 and a second edge 46. When the two cover segments 40,42 are connected to each other, the first edge 44 of the first cover segment 40 is releasably connected to the second edge 46 of the second cover segment 42 while the second edge 46 of the first cover segment 40 is releasably connected to the first edge 44 of the second cover segment 42. In other embodiments, the plant environment enclosure may comprise a plurality of cover segments each comprising a pair of first and second edges capable of releasably connecting the plurality of cover segments to each other.

The plant environmental enclosure 14 can be deployed in a similar way to the plant environmental enclosure 28 of FIGS. 5A-5C and its top portion 18 and wall portion 16 are selectively configurable to control the transfer of water between the plant container 2 and the surrounding environment.

In addition, as shown in FIGS. 6B and 6D-6F, each of the two cover segments 40,42 can be controlled independently. The two cover segments 40,42 can be in the same retracted state or in different retracted states. FIG. 6F shows that the plant environmental enclosure 38 having the first cover segment 40 in the extended state and the second cover segment 42 in the retracted state. FIGS. 6D-6F also show the varying release of moisture from the plant container 2 to the surrounding environment via the exposed lower portion 24 of the sidewall 6 when the two cover segments 40,42 are in different states (as indicated by way of arrows of different sizes).

Moreover, FIGS. 6A-6F show the plant environmental enclosure 38 comprising a plurality of wall portion retaining members 48 and connecting members 50. The wall portion retaining members 48 are arranged on the wall portion 16 along the length of the cover on each of the first cover segment 40 and the second cover segment 42. Each wall portion retaining member 48 is configured to retain a connecting member 50 to support the first cover segment 40 and/or the second cover segment 42 for retaining one or both in a selected retracted state.

The plurality of wall portion retaining members 48 forms two sets of wall portion retaining members 48 arranged on the wall portion 16 along the length of the cover, one set being arranged on each of the first cover segment 40 and the second cover segment 42. One connecting member 50 is arranged at a distal end of the wall portion 16 of each cover segment 40,42 proximate to the bottom side of the cover, each connecting member 50 being aligned with its respective set of wall portion retaining members 48. The wall portion retaining members and connecting members may be any suitable members that allow for a releasable connection such snap fasteners.

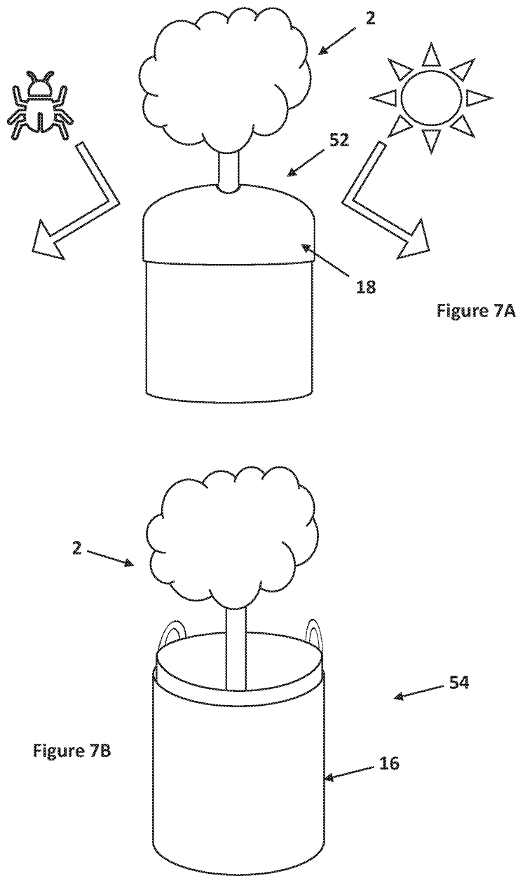

FIG. 7A shows a plant environmental enclosure 52 comprising only a top portion 18, i.e. not comprising a wall portion 16, having all the functionalities described in relation to FIGS. 2A-3B. The top portion 18 prevents the ingress of insects into the plant container 2 via its top and reflects sunlight. FIG. 7B shows a plant environmental enclosure 54 comprising only a wall portion 16, i.e. not comprising a top portion 18, having all the functionalities described in relation to FIGS. 4A-6F.

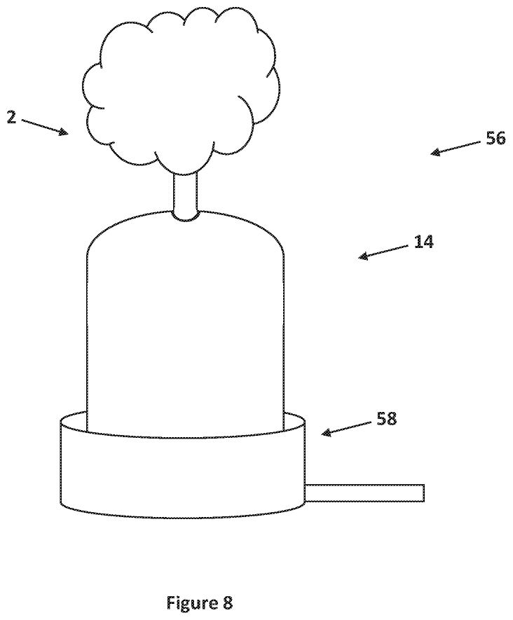

FIG. 8 shows a plant cultivation system 56 comprising a plant environmental enclosure 14, such as any of the ones described above, and the plant container 2 with a permeable sidewall 6 described in relation to FIG. 1. The plant cultivation system 56 further comprises a water supply system 58 that is configured to supply water to the plant 4 inside the plant container 2 via the permeable base 10 of the plant container 2. The water supply system 58 partly encloses the bottom of the sidewall 6.

The supply of water to the plant 4 via the water supply system 58 can be controlled via a mechanical controller such as a tap (not shown) or via an electronic controller such as a computer system (not shown). The supply of water via the water supply system 58 may be controlled based on sensor feedback from a humidity sensor configured to sense the humidity of the environment surrounding the plant environmental enclosure 14.

1. A plant environmental enclosure for a plant container with a permeable sidewall, the plant environmental enclosure comprising a cover configured to, in use, enclose at least part of the plant container,
wherein the cover is configurable in size to vary an area of the plant container that is, in use, covered by the cover, and
wherein the cover comprises a wall portion configured to, in use, at least partly enclose a sidewall of the plant container, the wall portion being selectively configurable between an extended state and at least one retracted state to vary an area of the sidewall of the plant container that is, in use, covered by the wall portion.

2. The plant environmental enclosure according to claim 1, wherein the wall portion is configured to, in use, at least partly wrap around the sidewall of the plant container.

3. (canceled)

4. The plant environmental enclosure according to claim 1, wherein the wall portion in the extended state is configured to, in use, fully enclose the sidewall of the plant container.

5. The plant environmental enclosure according to claim 1, wherein the wall portion in the at least one retracted state is configured to, in use, partly enclose the sidewall of the plant container.

6.-7. (canceled)

8. The plant environmental enclosure according to claim 1, wherein the plant environmental enclosure comprises at least one wall portion retaining member configured to releasably retain the wall portion in the at least one retracted state.

9. The plant environmental enclosure according to claim 1, further comprising at least one fastening element, wherein the cover comprises at least one cover segment defining a first edge and a second edge, the first edge and the second edge being releasably connectable by the at least one fastening element so that, in use, the cover encloses at least part of the plant container.

10. The plant environmental enclosure according to claim 1, wherein the cover comprises a top portion configured to, in use, at least partly enclose a top of the plant container, and wherein the top portion is configurable in size to vary an area of the plant container that is, in use, covered by the top portion.

11.-16. (canceled)

17. The plant environmental enclosure according to claim 1, wherein the wall portion in the extended state is configured to, in use, fully enclose the sidewall of the plant container, wherein the wall portion in the at least one retracted state is configured to, in use, partly enclose the sidewall of the plant container.

18. The plant environmental enclosure according to claim 1, wherein the wall portion in the extended state is configured to, in use, fully enclose the sidewall of the plant container, wherein the wall portion in the at least one retracted state is configured to, in use, partly enclose the sidewall of the plant container, wherein the plant environmental enclosure comprises at least one wall portion retaining member configured to releasably retain the wall portion in the at least one retracted state.

19. The plant environmental enclosure according to claim 1, wherein the wall portion in the extended state is configured to, in use, fully enclose the sidewall of the plant container, wherein the wall portion in the at least one retracted state is configured to, in use, partly enclose the sidewall of the plant container, wherein the plant environmental enclosure comprises at least one wall portion retaining member configured to releasably retain the wall portion in the at least one retracted state, wherein the cover defines an opening that is located, in use, on its bottom side and configured to, in use, allow access to a base of the plant container.

20. The plant environmental enclosure according to claim 1, wherein the wall portion in the extended state is configured to, in use, fully enclose the sidewall of the plant container, wherein the wall portion in the at least one retracted state is configured to, in use, partly enclose the sidewall of the plant container, wherein the plant environmental enclosure comprises at least one wall portion retaining member configured to releasably retain the wall portion in the at least one retracted state. wherein the cover defines an opening that is located, in use, on its bottom side and configured to, in use, allow access to a base of the plant container, wherein the cover comprises a top portion configured to, in use, at least partly enclose a top of the plant container, and wherein the top portion is configurable in size to vary an area of the plant container that is, in use, covered by the top portion.

21. The plant environmental enclosure according to claim 20, wherein the plant environmental enclosure comprises at least one top portion retaining member configured to releasably retain the top portion in one of an expanded state and a contracted state.

22. (canceled)

23. A plant environmental enclosure for a plant container with a permeable sidewall, the plant environmental enclosure comprising:
a cover configured to, in use, enclose at least part of the plant container,
wherein the cover is configurable in size to vary an area of the plant container that is, in use, covered by the cover, and
wherein an exterior facing surface of the cover includes a reflective material.

24. The plant environmental enclosure according to claim 23, wherein the cover comprises a wall portion configured to, in use, at least partly enclose the sidewall of the plant container.

25. The plant environmental enclosure according to claim 23, wherein the cover comprises a top portion configured to, in use, at least partly enclose a top of the plant container, and wherein the top portion is configurable in size to vary the area of the plant container that is, in use, covered by the top portion.

26. The plant environmental enclosure according to claim 25, wherein the top portion is configured to, in use, wrap around a stem of a plant extending therethrough.

27. A plant environmental enclosure for a plant container with a permeable sidewall, the plant environmental enclosure comprising:
a cover configured to, in use, enclose at least part of the plant container,
wherein the cover is configurable in size to vary an area of the plant container that is, in use, covered by the cover, and
wherein the cover defines an opening that is located, in use, on its bottom side and configured to, in use, allow access to a base of the plant container.

28. The plant environmental enclosure according to claim 27, wherein the cover comprises a wall portion configured to, in use, at least partly enclose the sidewall of the plant container.

29. The plant environmental enclosure according to claim 27, wherein the cover comprises a top portion configured to, in use, at least partly enclose a top of the plant container, and wherein the top portion is configurable in size to vary the area of the plant container that is, in use, covered by the top portion.

30. The plant environmental enclosure according to claim 29, wherein the top portion is configured to, in use, wrap around a stem of a plant extending therethrough.

31.-33. (canceled)
